(19) United States
(12) Patent Application Publication
(10) Pub. No.: US 2012/0218973 A1
(43) Pub. Date: Aug. 30, 2012

(54) Terminal and handover method

(75) Inventors: Zhongda Du, Shenzhen (CN); Zhongming Chen, Shenzhen (CN)

(73) Assignee: ZTE CORPORATION, Shenzhen, Guangdong (CN)

(21) Appl. No.: 13/504,944

(22) PCT Filed: Jan. 7, 2011
(86) PCT No.: PCT/CN2011/070102

§ 371 Date: Apr. 28, 2012

(30) Foreign Application Priority Data
Jan. 11, 2010 (CN) 201010004557.4

(51) Int. Cl. H04W 36/00; H04W 88/02; H04W 72/04

(52) U.S. Cl. 370/331

(57) ABSTRACT

The present invention discloses a handover method and a terminal. The method comprises the following steps: a terminal receiving a handover command, wherein the handover command is used to indicate that the terminal should be handed over to a target cell; the terminal performing a handover process so that it is handed over to the target cell and keeping a data communication with a source cell until a success of the handover process is determined. The present invention can reduce and even eliminate the interruption time of the handover in the mobility management so as to achieve a seamless handover and improve the service experience for the users.

### FIELD OF THE INVENTION

The present invention relates to the field of communications, and in particular to a handover method and a terminal.

### BACKGROUND OF THE INVENTION

FIG. 1 shows a diagram of the protocol stack between a user equipment (UE), or called a terminal, and an eNode-B (eNB) according to the relevant technology; as shown in FIG. 1, the protocol stack of an interface between the UE and the eNB in a long term evolution (LTE) system is divided into a plurality of protocol layers as follows from the bottom to the top: physical layer (PHY), media access control (MAC) layer, radio link control (RLC) layer, packet data convergence protocol (PDCP) layer, and radio resource control (RRC) layer, in which, the PHY layer mainly transmits information to the MAC or higher layers through a transmission channel; the MAC layer mainly provides data transmission through a logic channel and takes charge of radio resource allocation, to finish the functions such as hybrid automatic repeat request (HARQ), scheduling (SCH), priority processing and multiplexing (MUX); the RLC layer mainly provides the segmentation and retransmission services of the user data and control data; the PDCP layer mainly finishes the data transmission for the RRC or user plane upper layer; the RRC mainly finishes broadcast, paging, radio resource control connection management, radio bearer control, mobility function, terminal measurement report and control. Before the UE sends data to the eNB, the UE needs to acquire the uplink synchronization with the eNB, that is, acquire time advance (TA) of transmission time; wherein the UE achieves the object above by a random access process which is implemented in the MAC layer.

In order to provide higher data rate for mobile subscribers, the long term evolution advance (LTE-A) system proposes a carrier aggregation (CA) technology, with a purpose of providing greater broadband for the UE with corresponding capability to improve the peak rate of UE. In the LTE, the greatest downlink transmission band width supported by system is 20 MHz; the CA technology is to aggregate two or more component carriers (CC) to support a transmission band width greater than 20 MHz but not exceeding 100 MHz. The interface protocol stack between UE and eNB is mainly reflected in the difference between the MAC layer and the PHY layer. In the PHY layer, CC is dedicated, and the difference of the MAC layer can be seen by taking FIG. 2 (FIG. 5.2.1-2 Layer 2 Structure for the UL in 36.912) for example; in the MAC layer, for the HARQ, CC is dedicated; for the scheduling, priority processing and multiplexing, CC is common.

At present, in the condition that frequency spectrum resource is tense, there might exist a phenomenon that continuous CCs on a frequency domain can not be allocated to an operator to use; therefore, CA can be divided into continuous CA and discontinuous CA according to whether each CC is continuous on the frequency domain, wherein the continuous CA means that each CC on the frequency domain is continuous, while the discontinuous CA means that each CC on the frequency domain is not continuous. The CA can be divided into single-band CA and over-multiple-frequency-band CA according to whether each CC is in the same frequency band, wherein the single band CA means that all CCs participating the CA are in the same frequency band, and the single band CA can be continuous CA or discontinuous CA; the over-multiple-frequency-band CA means that the CCs participating the CA can be from different frequency bands, and the over-multiple-frequency-band CA can only be discontinuous CA. The LTE-A UE with CA capability can transmit and receive data on a plurality of CCs at the same time, while the LTE UE can only transmit and receive data on an LTE compatible CC. Correspondingly, the transmitting equipment and receiving equipment of the UE can be a set of base band equipment, with a single frequency band which has a band width greater than 20 MHz, also can be a plurality of base band equipment, with multiple frequency bands each of which has a band width less than 20 MHz.

In a mobile communication system, in order to guarantee service quality and provide good service experience for users, when a UE establishes a connection with a network in a cell, the UE still needs to measure the signal quality of the serving cell and adjacent cells and selects a proper cell to perform handover, so as to meet the mobility requirement. FIG. 3 shows a flowchart of the handover according to the relevant technology; as shown in FIG. 3, in the LTE system, when the UE receives a command from the network side and needs to perform handover (point A shown in FIG. 3), the user plane reset (including the reset of the MAC layer, the reconstruction of the PDCP layer and the reconstruction of the RLC layer) is performed and the configurations of the MAC layer, the PDCP layer and the RLC layer are updated according to the handover command, the configuration including configuring the bottom layer to adopt an integrity protection algorithm and a ciphering algorithm of the target cell, and a random access is performed at the target cell, after the random access is finished, the UE can communicate with the target cell (point B shown in FIG. 3); finally, the UE sends a handover complete command to the target cell. When the UE performs the random access process at the target cell, due to the capability of the UE, the data communication between the UE and the source cell needs to be interrupted. Between point A and point B, the UE can not communicate with the source cell or the target cell normally, and this period is called the interruption time of handover, wherein the interruption time is the time occupied by the random access process, that is, the time from the start of the random access to the end of the random access.

In the scene of CA, the interruption time of handover in the mobility management is required to be 10.5 milliseconds (referring to section 16.5 in 36.912, Table 16.3-1: U-Plane interruption in LTE-Advanced); in present actual condition, the interruption time is between 20 milliseconds to 30 milliseconds. From the description in the Table 16.5-1 in 36.912, the time occupied by the random access process is a main constituent part of the interruption time of handover; if the terminal handover time is too long, the normal service of the UE would be seriously impacted.

### SUMMARY OF THE INVENTION

The main object of the present invention is to provide a handover scheme, for solving the problem in the relevant technology that the normal service of the terminal is impacted due to a long handover interruption time caused by the long time occupied by the random access process.

In order to realize the object above, according to one aspect of the present invention, a handover method is provided.

The handover method according to the present invention comprises the following steps: a terminal receiving a handover command, wherein the handover command is used to indicate that the terminal should be handed over to a target cell; and the terminal performing a handover process so that it is handed over to the target cell and keeping a data communication with a source cell until a success of the handover process is determined.

In order to realize the object above, according to another aspect of the present invention, a terminal is provided.

The terminal according to the present invention comprises: a handover module used for receiving a handover command, wherein the handover command is used to indicate that the terminal should be handed over to a target cell; a communication module used for performing a handover process so that it is handed over to the target cell; and a first data communication module used for keeping a data communication with a source cell until a success of the handover process is determined.

By the method that the terminal performs a handover process of handing itself over to a target cell and keeps the data communication with a source cell until success of the handover process is determined, the present invention solves the problem in the relevant technology that the normal service of the terminal is impacted due to a long handover interruption time caused by the long time occupied by the random access process, thereby reducing and even eliminating the interruption time of the handover in the mobility management so as to achieve a seamless handover and improve the service experience for the users.

### BRIEF DESCRIPTION OF THE DRAWINGS

For a better understanding of this invention, accompanying drawings described hereinafter are provided to constitute one part of the application; the schematic embodiments of this invention and the description thereof are used to illustrate the present invention but to constitute an improper limit for the present invention. In the accompanying drawings:

FIG. 1 shows a diagram of the protocol stack between UE and eNB according to the relevant technology;

FIG. 2 shows a structure diagram of MAC uplink according to the relevant technology;

FIG. 3 shows a flowchart of the handover according to the relevant technology;

FIG. 4 shows a flowchart of a handover method according to the embodiment of the present invention;

FIG. 5 shows a diagram of a handover method according to the embodiment of the present invention;

FIG. 6 shows a flow diagram of a handover method according to the embodiment of the present invention;

FIG. 7 shows a diagram of UE composition structure according to the relevant technology;

FIG. 8 shows a diagram of UE composition structure according to embodiment of the present invention;

FIG. 9 shows a diagram of a first preferred example according to the embodiment of the present invention;

FIG. 10 shows a flowchart of a first preferred example according to the embodiment of the present invention;

FIG. 11 shows a diagram of a second preferred example according to the embodiment of the present invention;

FIG. 12 shows a diagram of a third preferred example according to the embodiment of the present invention;

FIG. 13 shows a flowchart of a third preferred example according to the embodiment of the present invention;

FIG. 14 shows a diagram of a fourth preferred example according to the embodiment of the present invention;

FIG. 15 shows a diagram of a fifth preferred example according to the embodiment of the present invention.

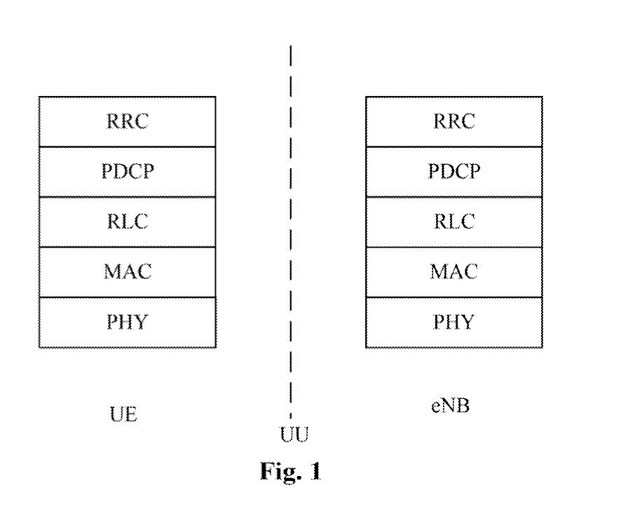

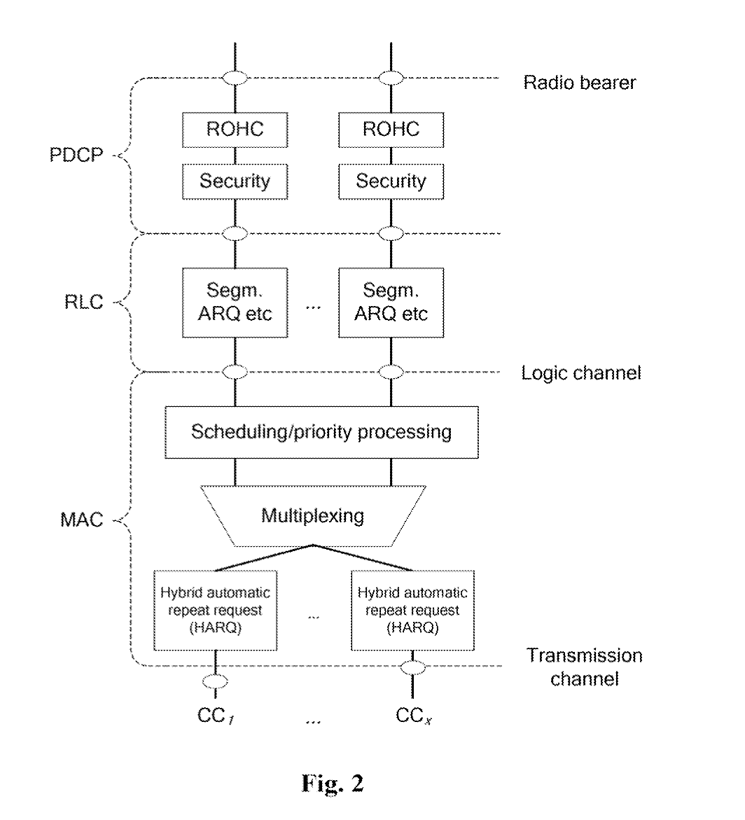

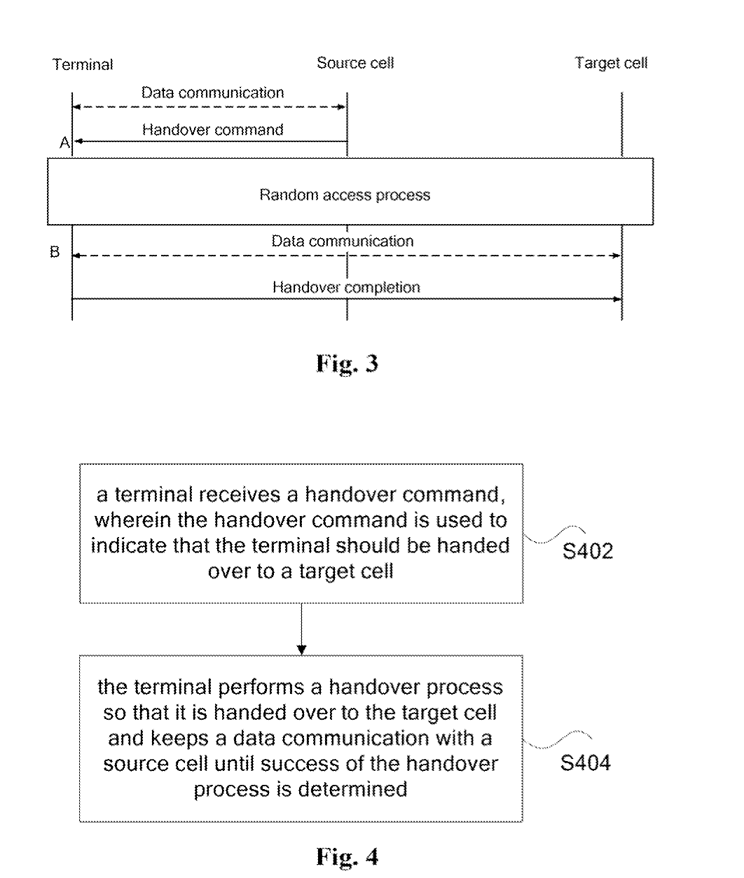

### DETAILED DESCRIPTION OF THE INVENTION

The present invention is described below in detail by reference to the accompanying figures in conjunction with embodiments. It should be noted that the embodiments and the characteristics of the embodiments in the present invention can be combined if no conflict is caused.

According to the embodiment of the present invention, a handover method is provided. FIG. 4 shows a flowchart of a handover method according to the embodiment of the present invention; as shown in FIG. 4, the method comprises the following steps that:

S402: a terminal receives a handover command, wherein the handover command is used to indicate that the terminal should be handed over to a target cell.

S404: the terminal performs a handover process so that it is handed over to the target cell and keeps a data communication with a source cell until a success of the handover process is determined, wherein the handover process comprises: a random access process.

Specifically, the method can be understood as that: the terminal keeps the data communication with the source cell before the handover; after receiving a command of handing itself over to a target cell, the terminal performs the handover process of handing itself over to the target cell; preferably, after determining the success of handing itself over to the target cell (for example, after the random aces process is completed), the terminal terminates the data communication with the source cell and starts a data communication with the target cell, or the terminal first starts a data communication with the target cell and then terminates the data communication with the source cell.

Hereafter, the terminal sends a handover complete message to the target cell.

The random access process above comprises one of the following: random access process with conflicts and random access process without conflict.

In which, the step that the terminal performs the random access process with conflicts of handing itself over to the target cell comprises the following steps that:

(1) the terminal sends a random access preamble to the target cell, wherein the random access preamble carries a common preamble;

(2) the terminal receives a random access response message from the target cell, wherein the random access response message carries TA and/or uplink grant information;

(3) the terminal sends a Message3 to the target cell, wherein the Message3 is a MAC layer message or a physical layer message; preferably, the Message3 is a control cell of MAC layer and carries a cell-radio network temporary identity (C-RNTI) of the terminal at the target cell;

(4) the terminal receives a Message4 from the target cell and confirms that the random access conflict is resolved, wherein the Message4 is a MAC layer message or a physical layer message, containing a physical layer physical downlink control channel (PDCCH) signaling; wherein the PDCCH signaling contains the content of the C-RNTI of the terminal at the target cell. If the terminal receives the Message4 and confirms that the conflict is resolved, the terminal considers (determines) that the handover process is successful.

After Step (4), the method further comprises a step: the terminal sends a Message5 to the target cell, wherein the Message5 is used to indicate the completion of handover.

It should be noted that: the target cell is configured to send the random access response message and/or Message4 to the terminal directly or via the source cell; the terminal is configured to send the Message3 to the target cell directly or via the source cell.

In which, the step that the terminal performs the random access process without conflict of handing itself over to the target cell comprises the following steps that: the terminal sends a random access preamble to the target cell, wherein the random access preamble carries a dedicated preamble and is a dedicated resource configured for the terminal by the target cell; then the terminal receives a random access response message directly sent by the target cell, or the terminal receives a random access response message sent by the target cell via the source cell, wherein the random access response message carries TA and/or uplink grant information; after receiving the random access response message, the terminal considers (determines) that the handover process is successful; after determining the success of the handover process, the terminal sends to the target cell a Message3 which is used to indicate the completion of handover.

After the terminal receives the handover command and before the terminal determines the success of the handover process, one or more uplink carriers and/or one or more downlink carriers update the configuration of an underlying protocol according to the handover command and perform the random access process with the target cell.

After determining the success of the handover process, the terminal updates the configuration of the underlying protocol of other carriers according to the handover command, wherein other carriers refer to the configured carriers in the handover command other than those carriers performing the random access process.

The underlying protocol above is the carrier-related MAC layer protocol and physical layer protocol.

After determining the success of the handover process, the terminal updates the configuration of a high-layer protocol according to the handover command.

The high-layer protocol comprises carrier-unrelated PDCP, RLC and MAC layer protocols.

The high-layer protocol comprises carrier-unrelated RRC layer protocol.

After determining the success of the handover process, the terminal accomplishes the reset process of the user interface protocol, wherein the reset comprises MAC layer reset, PDCP layer reconstruction and RLC layer reconstruction.

The user interface protocol comprises PDCP, RLC and MAC layer protocols.

With the embodiment above, the terminal is enabled to keep the data communication with the source cell still during the random access process at the target cell, thus the interruption time of the handover in the mobility management can be reduced and even eliminated. Besides, it is defined that the time for terminating the data communication between the terminal and the source cell is after the completion of the random access process.

It should be noted that the data communication mentioned in the embodiment refers to the exchange of packet of use plane or control plane between the terminal and eNB. The main function of the handover execution process is that the terminal obtains the uplink synchronization information on the target cell so as to start the data communication with the target cell. Generally, the handover execution process comprises a random access process. Provided that the uplink random access resource during the random access process is decided by the terminal itself, then the random access process also needs to solve the problem of identity conflict.

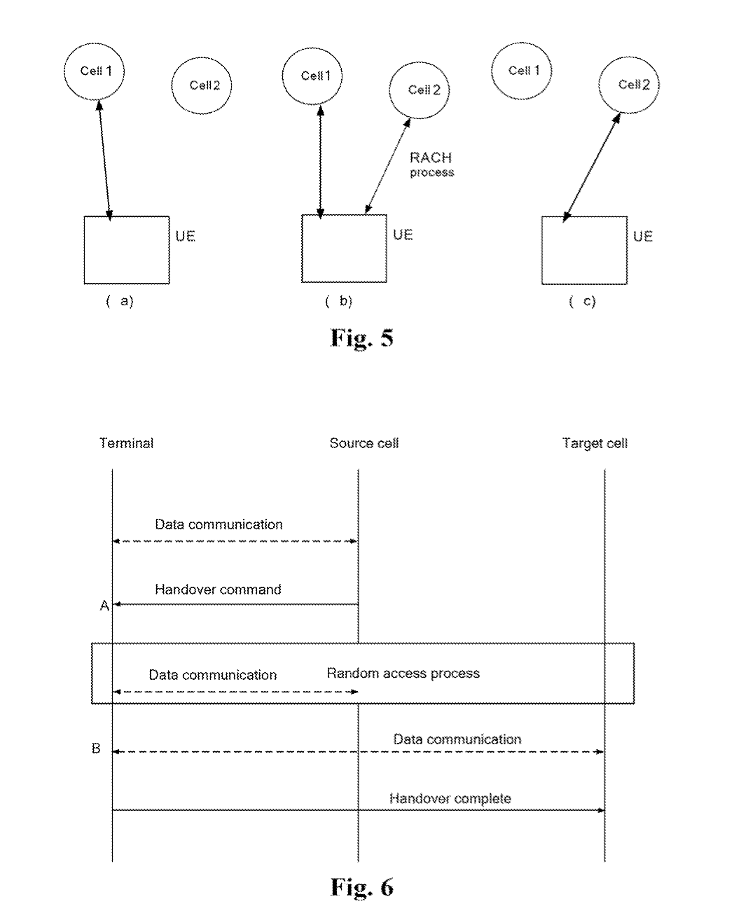

The steps above are illustrated below in conjunction with FIG. 5 and FIG. 6. FIG. 5 shows a diagram of a handover method according to the embodiment of the present invention; as shown in FIG. 5, in (a) of FIG. 5, the UE communicates with the source cell (for example, cell 1) normally; in (b) of FIG. 5, the UE receives a command of handing itself over to the target cell (for example, cell 2), and the UE immediately initiates a random access to the cell 2, however, the communication between the UE and the cell 1 is still maintained; in (c) of FIG. 5, the UE performs the random access to the cell 2 successfully, communicates with the cell 2 normally and terminates the communication with the cell 1; then the handover is completed.

FIG. 6 shows a flow diagram of a handover method according to the embodiment of the present invention; as shown in FIG. 6, the terminal performs the data communication with the source cell at first; at point A in FIG. 6, the terminal receives a handover command; while keeping the communication with the source cell, the terminal starts to initiate a random access process on the target cell; after the completion of the random access process, the terminal terminates the communication with the source cell at point B and starts to communicate with the target cell. The terminal also informs the target cell of a handover complete message.

Preferably, the target cell and the source cell can be in the same eNB, also can be in different eNBs; can be synchronous in time or asynchronous in time; can be in the same frequency band, also can be in different frequency bands.

Preferably, the steps above might not be executed based on the sequence above; for example, at point B, the terminal can first start the communication with the target cell and then interrupt the communication with the source cell.

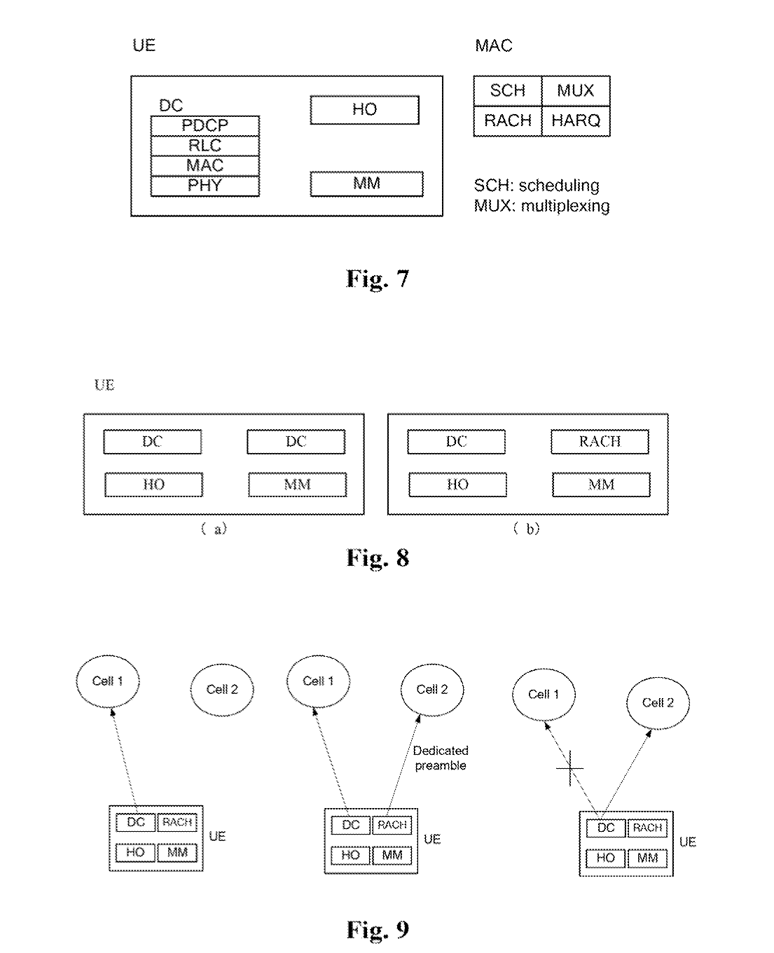

In the relevant technology, in order to complete the handover operation, the UE may comprise several logic modules as follows: a handover module (including the module receiving a handover command of network side, simplified as HO), a measurement module (including the module receiving a measurement control command of network side and performing measurement and measurement report, simplified as MM), a data communication module (the module performing exchange of packet of user plane or control plane with eNB, simplified as DC). FIG. 7 shows a diagram of UE composition structure according to the relevant technology; as shown in FIG. 7, in terms of the protocol layer, the data communication module from the bottom to the top comprises the processing of PHY, MAC, RLC and PDCP protocol layers; of course, the data communication module also comprises a module for performing the random access process on the MAC layer, wherein the MAC layer approximately is divided into SCH, MUX, RACH and HARQ.

FIG. 8 shows a diagram of UE composition structure according to the embodiment of the present invention; as shown in FIG. 8, in order to complete the handover in the embodiment, according to the capability of UE, there might be more DC modules, as shown in (a) of FIG. 8. Another implementation mode of the terminal is as shown in (b) of FIG. 8, a random access channel (RACH) module is added in (b), wherein the RACH module is a single module separated from the DC module, can work based on the downlink system time of the target cell and can finish the random access function including conflict or non-conflict based random access process. For the conflict based random access process, the RACH module also needs to finish the function of HARQ. The RACH needs a corresponding separate PHY layer. The handover of the embodiment is described below in detail in conjunction with the modules in the terminal.

According to the embodiment of the present invention, the provided terminal comprises: a handover module used for receiving a handover command, wherein the handover command is used to indicate that the terminal should be handed over to a target cell; a communication module used for performing a handover process of handing itself over to the target cell; a first data communication module used for keeping the data communication with a source cell until success of the handover process is determined.

It should be noted that the communication module comprises one of the following: a random access RACH module, a second data communication module.

Preferably, when the handover process is a random access process, the first data communication module is further used for terminating the data communication with the source cell, after the communication module completes the random access process of handing itself over to the target cell.

Preferably, the second data communication module is further used for starting a data communication with the target cell after or before the first data communication module terminates the data communication with the source cell, and sending a handover complete message to the target cell when determining the success of the handover process after or before the first data communication module terminates the data communication with the source cell.

Preferably, when performing the random access process with conflicts of handing itself over to the target cell, the communication module is further used for sending to the target cell a random access preamble which carries a common preamble code, receiving from the target cell a random access response message which carries TA and/or uplink grant information, sending, to the target cell, a Message3 which is a MAC layer message or a physical layer message and carries a C-RNTI of the terminal at the target cell, receiving from the target cell a Message4 and confirming that the random access conflict is resolved, wherein the Message4 is a MAC layer message or a physical layer message and contains the physical layer PDCCH signaling that contains the content of the C-RNTI of the terminal at the target cell; after the terminal receives the Message4 and confirms that the conflict is resolved, the terminal considers (determines) that the handover process is successful, and sends to the target cell a Message5 which is used to indicate the completion of the handover process.

Preferably, when performing the random access process without conflict of handing itself over to the target cell, the communication module is further used for sending to the target cell a random access preamble which carries a dedicated preamble that is a dedicated resource configured for the terminal by the target cell, receiving the random access response message sent by the target cell directly or receiving the random access response message sent by the target cell via the source cell, wherein the random access response message carries TA and/or uplink grant information; after the terminal receives the random access response message, the terminal considers (determines) that the handover process is successful, and sends to the target cell a Message3 which is used to indicate the completion of the handover.

After the handover module receives the handover command and before the success of the handover process, the communication module has one or more uplink carriers and/or one or more downlink carriers updating the configuration of underlying protocol according to the handover command and performing the random access process with the target cell, wherein the underlying protocol is the carrier-related MAC layer protocol and physical layer protocol.

After the success of the handover process, the communication module is further used for updating the configuration of the underlying protocol of other carriers according to the handover command, wherein other carriers refer to the configured carriers in the handover command other than the carriers performing the random access process; the underlying protocol is the carrier-related MAC layer protocol and physical layer protocol.

After the success of the handover process, the communication module is further used for updating the configuration of high-layer protocol according to the handover command, wherein the high-layer protocol comprises carrier-unrelated PDCP, RLC and MAC layer protocols.

The preferred examples of the embodiment are described below in detail in conjunction with accompanying drawings. In the following preferred examples, each CC is synchronous or asynchronous in the LTE-A cell; the carrier of the source cell and the carrier of the target cell in LTE or LTE-A are synchronous or asynchronous; the source cell and the target cell of LTE or LTE-A are in the same eNB, or different eNBs, wherein the processing is the same.

### Preferred Example 1

FIG. 9 shows a diagram of a first preferred example according to the embodiment of the present invention; as shown in FIG. 9, cell 1 is the cell of LTE and supports a CC1 which is located in the frequency band 1; cell 2 is the cell of LTE, wherein the cell 2 is an adjacent cell of the cell 1 and supports a CC2 which is located in the frequency band 1. The transmitting equipment and receiving equipment of the UE is a set of base band equipment, which has a single frequency band with band width less than 20 MHz, a first data communication module and an RACH module that has a corresponding PHY layer; the cell 1 belongs to eNB 1 and the cell 2 belongs to eNB 2.

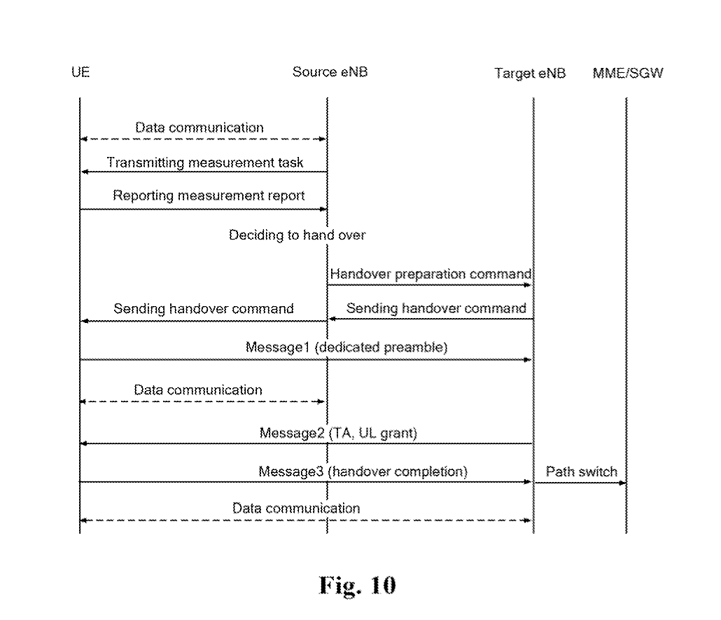

FIG. 10 shows a flowchart of a first preferred example according to the embodiment of the present invention; the flow of the example is described below in conjunction with FIG. 10.

The current UE is in a connection state in the cell 1. The network side transmits to the UE a measurement task (measurement control) of a trigger event (A3) that the adjacent cell has better quality of service than the serving cell, wherein the carrier frequency of the measured object is CC2.

The UE performs the measurement, finds that the CC2 of the cell 2 meets the trigger condition of the event A3 and sends the measurement report to the network side.

The network side decides to enable the UE to hand over to the cell 2 (handover decision), and sends a handover preparation command (handover request) to the cell 2.

After receiving the handover preparation command, the cell 2 allocates a preamble which is included in the handover command (handover request ACK) to be sent to the cell 1, wherein the handover command further includes the C-RNTI, allocated by the cell 2, of the terminal on the cell 2, the information of the cell 2 (for example, including CC2 and the related information of CC2, other information of the cell 2), then the cell 1 forwards the handover command to the UE (RRC reconfiguration (handover)).

After the UE receives the handover command, the RACH module and the corresponding physical layer update the configuration of underlying protocol according to the requirement of handover command, and perform the random access process with the cell 2; that is, the RACH module of the terminal sends a random access preamble (Message1) to the cell 2 through the corresponding physical layer, wherein the Message1 contains the dedicated preamble provided by the cell 2; the dedicated preamble is a dedicated resource configured for the terminal by the cell 2.

After receiving the Message1, the cell 2 reserves resource for the UE and returns a Message2 to the UE, the Message2 including TA and/or the grant information transmitted by the UE on uplink (UL grant).

After the UE receives the Message2, the function execution of the RACH module is finished, the random access process without conflict executed at the cell 2 is ended, the UE obtains the downlink synchronization with the cell 2 and TA, considers that the handover is successful, accomplishes the reset process of the user interface protocol, the reset including MAC layer reset, PDCP layer reconstruction and RLC layer reconstruction, updates the configurations of the carrier-related MAC and PHY layers of the first data communication module and updates the configurations of the carrier-unrelated RRC, PDCP, RLC and MAC layer protocols according to the handover command, the configuration including configuring the bottom layer to adopt an integrity protection algorithm and a ciphering algorithm of the cell 2, starts the communication with the cell 2, sends to the cell 2 a Message3 (HO complete) which is used to indicate the completion of handover, then the cell 2 notifies the core network to perform path switch and the first data communication module terminates the communication with the cell 1.

### Preferred Example 2

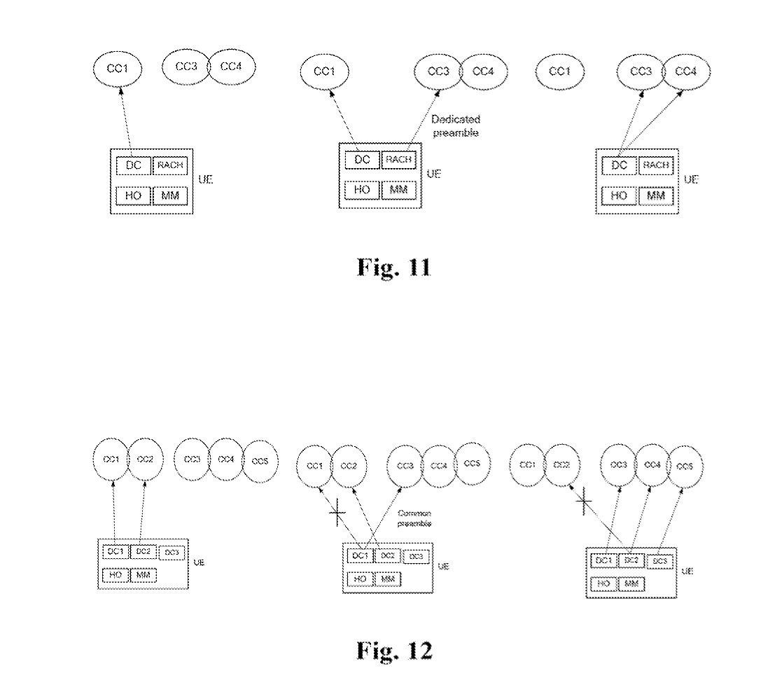

FIG. 11 shows a diagram of a second preferred example according to the embodiment of the present invention; as shown in FIG. 11, cell 1 is the cell of LTE and supports a CC1 which is located in the frequency band 1; cell 2 is the cell of LTE-A, wherein the cell 2 is an adjacent cell of the cell 1 and supports the aggregation of two CCs, that is, CC3 and CC4, both of which are located in the frequency band 1 and are continuous. The transmitting equipment and receiving equipment of the UE is a set of base band equipment, which has a single frequency band with band width of 40 MHz, a first data communication module, an RACH module that has a corresponding PHY layer; the cell 1 belongs to eNB 1 and the cell 2 belongs to eNB 2.

The current UE is in a connection state in the cell 1. The first data communication module takes charge of the data communication with the cell 1 on the CC1. The network side transmits to the UE a measurement task of a trigger event (A3) that the adjacent cell has better quality of service than the serving cell, wherein the carrier frequency of the measured object is CC3 and CC4; for the flow, refer to the flow shown in FIG. 10 in Embodiment one, no further description is needed here.

The UE performs the measurement, finds that the CC3 and CC4 of the cell 2 meet the trigger condition of the event A3 and sends the measurement report to the network side.

The network side decides to enable the UE to hand over to the cell 2, and sends a handover preparation command to the cell 2.

After receiving the handover preparation command, the cell 2 allocates a preamble, selects a CC as the CC for the UE to perform the random access at the cell 2 (for example, CC3) and includes the information in the handover command to send to the cell 1, wherein the handover command further includes the C-RNTI allocated by the cell 2, the information of the cell 2 (for example, including CC3 and CC4, information of each carrier and other information of the cell 2), then the cell 1 forwards the handover command to the UE.

After the UE receives the handover command, the RACH module and the corresponding physical layer update the configuration of underlying protocol according to the requirement of handover command, and perform the random access process with the cell 2; that is, the RACH module of the terminal sends a Message1 on the CC3, wherein the Message1 contains the dedicated preamble provided by the cell 2.

After receiving the Message1 , the cell 2 reserves resource for the UE and returns a Message2 to the UE on CC3, wherein the Message2 includes TA and/or UL grant; the cell 2 also can forward the Message2 to the UE through the cell 1.

After the UE receives the Message2 on the CC3, the function execution of the RACH module is finished, the random access process without conflict at the cell 2 is ended, the UE obtains the downlink synchronization with the cell 2 and TA, considers that the handover process is successful, accomplishes the reset process of the user interface protocol, the reset including MAC layer reset, PDCP layer reconstruction and RLC layer reconstruction, updates the configurations of the carrier-related MAC and PHY layers of the first data communication module and updates the configurations of the carrier-unrelated RRC, PDCP, RLC and MAC layer protocols according to the handover command, the configuration including configuring the bottom layer to adopt an integrity protection algorithm and a ciphering algorithm of the cell 2, starts the communication with the cell 2, sends to the cell 2 a Message3 (handover complete), then the cell 2 notifies the core network to perform path switch and the first data communication module completely terminates the communication with the cell 1; after that, the cell 2 can add CC4 according to the requirement; the UE may initiate a random access process on the CC4 or not according to whether the CC4 is synchronous with the CC3.

### Preferred Example 3

FIG. 12 shows a diagram of a third preferred example according to the embodiment of the present invention; as shown in FIG. 12, cell 1 is the cell of LTE-A and supports the aggregation of two CCs, that is, CC1 and CC2, both of which are located in the frequency band 1 and are discontinuous; cell 2 is the cell of LTE-A, wherein the cell 2 is an adjacent cell of the cell 1 and supports the aggregation of three CCs, that is, CC3, CC4 and CC5, of which the CC3 and CC4 are located in the frequency band 2 and are discontinuous, and the CC5 is located in the frequency band 3. The transmitting equipment and receiving equipment of the UE is three sets of base band equipment, with three frequency bands each of which has a band width less than 20 MHz, that is to say, and the UE has three first data communication modules. Both cell 1 and cell 2 belong to eNB 1.

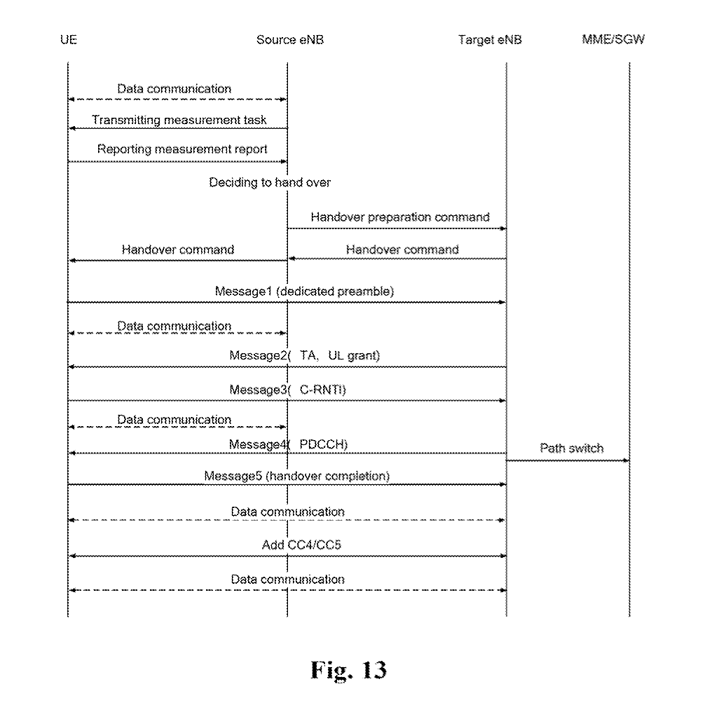

FIG. 13 shows a flowchart of a third preferred example according to the embodiment of the present invention; the flow of the example is illustrated below in conjunction with FIG. 13.

The current UE is in a connection state in the cell 1 and uses the CC1 and the CC2 at the same time; the first data communication module 1 takes charge of the data communication on the CC1; the first data communication module 2 takes charge of the data communication on the CC2; and the first data communication module 3 is idle. The network side transmits to the UE a measurement task of a trigger event (A3) that the adjacent cell has better quality of service than the serving cell, wherein the carrier frequency of the measured object is CC3, CC4 and CC5.

The UE performs the measurement, finds that the CC3, CC4 and CC5 of the cell 2 meet the trigger condition of the event A3 and sends the measurement report to the network side.

The network side decides to enable the UE to hand over to the cell 2, and sends a handover preparation command to the cell 2.

After receiving the handover preparation command, the cell 2 includes the information (for example, including CC3, CC4 and CC5, information of each carrier and other information of the cell 2) of the cell 2 in the handover command to send to the cell 1, wherein the handover command further includes the C-RNTI allocated by the cell 2, then the cell 1 forwards the handover command to the UE and notifies the first data communication module 1 of the UE to interrupt the data communication with the cell 1 and switch to the second data communication module to initiate a random access process on the cell 2.

After the UE receives the handover command, the CC1 related MAC layer, PHY layer and the corresponding physical layer of the first data communication module 1 update the configuration of underlying protocol according to the handover command, and perform the random access process with the cell 2, that is, interrupt the communication with the cell 1 on the CC1, switch to the second data communication module and select to initiate on the CC3 a random access process, that is, to send a Message1 including a common preamble. Since the UE has three sets of base band equipment, at this moment, the UE might not interrupt the communication with the cell 1 on the first data communication module 1, but transform the first data communication module 3 to the second data communication module to initiate a random access process of the cell 2 on the CC3.

After receiving the Message1, the cell 2 reserves resource for the UE and returns a Message2 to the UE on CC3, wherein the Message2 includes TA and/or UL grant; the Message2 also can be forwarded to the UE by the cell 1.

After receiving the Message2 on the CC3, the UE performs the related processing and sends a Message3 to the cell 2, wherein the Message3 is a MAC layer message or a physical layer message, including the C-RNTI of the terminal on the cell 2; if the UE receives the Message2 forwarded by the cell 1, the Message3 also can be forwarded to the cell 2 by the cell 1.

After receiving the Message3, the cell 2 starts to send a Message4 on the CC3, wherein the Message4 is a MAC layer message or a physical layer message, containing the physical layer PDCCH signaling in which the content of the C-RNTI of the terminal at the target cell is contained, then the cell 2 notifies the core network to perform path switch.

After receiving the PDCCH on the CC3, the UE confirms that the random access conflict is resolved, the random access process with conflicts of the UE at the cell 2 is ended, the UE obtains the downlink synchronization with the cell 2 and TA, and thus considers that the handover process is successful, accomplishes the reset process of the user interface protocol, the reset including MAC layer reset, PDCP layer reconstruction and RLC layer reconstruction, updates the configurations of the carrier-related MAC and PHY layers of the first data communication modules 2 and 3 and updates the configurations of the carrier-unrelated RRC, PDCP, RLC and MAC layer protocols according to the handover command, the configuration including configuring the bottom layer to adopt an integrity protection algorithm and a ciphering algorithm of the cell 2, the UE starts to communicate with the cell 2 normally and sends a Message5 (handover complete) to the cell 2, the UE starts to communicate with the cell 2 normally and can completely interrupt the communication with the cell 1 at this moment; after that, the cell 2 can add CC4 and CC5 according to the requirement; the UE may initiate a random access process on the CC4 and CC5 or not according to whether the CC4 and CC5 are synchronous with the CC3.

### Preferred Example 4

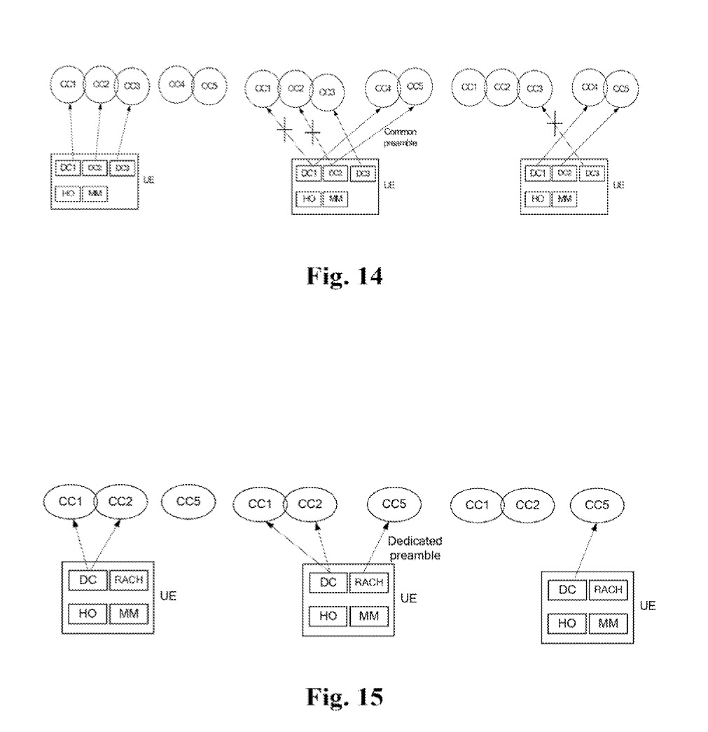

FIG. 14 shows a diagram of a fourth preferred example according to the embodiment of the present invention; as shown in FIG. 14, cell 1 is the cell of LTE-A and supports the aggregation of three CCs, that is, CC1, CC2 and CC3, all of which are located in the frequency band 1 and are discontinuous; cell 2 is the cell of LTE-A, wherein the cell 2 is an adjacent cell of the cell 1 and supports the aggregation of two CCs, that is, CC4 and CC5, both of which are located in the frequency band 2 and are discontinuous. The transmitting equipment and receiving equipment of the UE is three sets of base band equipment, with three frequency bands each of which has a band width less than 20 MHz, that is to say, and the UE has three first data communication modules. The cell 1 belongs to eNB 1 and the cell 2 belongs to eNB 2.

The current UE is in a connection state in the cell 1 and uses CC1, CC2 and CC3 at the same time; DC1, DC2 and DC3 take charge of the data communication on the CC1, CC2 and CC3 respectively. The network side transmits to the UE a measurement task of a trigger event (A3) that the adjacent cell has better quality of service than the serving cell, wherein the carrier frequency of the measured object is CC4 and CC5. The process can be referred to FIG. 13 in Example 3, and no further description is needed here.

The UE performs the measurement, finds that the CC4 and CC5 of the cell 2 meet the trigger condition of the event A3 and sends the measurement report to the network side.

The network side decides to enable the UE to hand over to the cell 2, and sends a handover preparation command to the cell 2.

After receiving the handover preparation command, the cell 2 includes the information (for example, including CC4 and CC5, information of each carrier and other information of the cell 2) of the cell 2 in the handover command to send to the cell 1, wherein the handover command further includes the C-RNTI4 on the CC4 and the C-RNTI5 on the CC5 allocated by the cell 2, then the cell 1 forwards the handover command to the UE.

After receiving the handover command, the UE decides to make the CC1 related MAC layer, PHY layer and the corresponding physical layer of the first data communication module 1 update the configuration of underlying protocol according to the handover command, and perform the random access process with the cell 2; that is, interrupt the communication with the cell 1 on the CC1 and select to initiate on the CC4 a random access process of the cell 2, that is, to send a Message1 which includes a common preamble and the C-RNTI4. The UE also decides to make the CC2 related MAC layer, PHY layer and the corresponding physical layer of the first data communication module 2 update the configuration of underlying protocol according to the handover command, and perform the random access process with the cell 2; that is, interrupt the communication with the cell 1 on the CC2 and select to initiate on the CC5 a random access process of the cell 2, that is, to send a Message1 which includes a common preamble and the C-RNTI5. In the following process, the CC4 and the CC5 are independent.

After receiving the Message1 on the CC4, the cell 2 reserves resource for the UE and returns a Message2 to the UE on CC4, wherein the Message2 includes TA and/or UL grant; after receiving the Message1 on the CC5, the cell 2 reserves resource for the UE and returns a Message2 to the UE on CC5, wherein the Message2 includes TA and/or UL grant.

After receiving the Message2 on the CC4, the UE performs the related processing and sends a MAC CE including C-RNTI4 to the cell 2 on the CC4; after receiving the Message2 on the CC5, the UE performs the related processing and sends a MAC CE including C-RNTI5 to the cell 2 on the CC5.

After receiving the Message2 on the CC4, the cell 2 starts to send PDCCH on the CC4; after receiving the Message2 on the CC5, the cell 2 starts to send PDCCH on the CC5. The cell 2 notifies the core network to perform path switch.

After receiving the PDCCH on the CC4 and the PDCCH on the CC5, the UE confirms that the random access conflict is resolved, the random access process with conflicts at the cell 2 is ended, thus the UE obtains the downlink synchronization with the cell 2 and TA, considers that the handover process is successful, accomplishes the reset process of the user interface protocol, the reset including MAC layer reset, PDCP layer reconstruction and RLC layer reconstruction, updates the configurations of the carrier-related MAC and PHY layers of the first data communication module 3 and updates the configurations of the carrier-unrelated RRC, PDCP, RLC and MAC layer protocols according to the handover command, the configuration including configuring the bottom layer to adopt an integrity protection algorithm and a ciphering algorithm of the cell 2, the UE starts to communicate with the cell 2 and sends a Message5 (handover complete) to the cell 2. If the UE only receives the PDCCH on the CC4, it can be considered that the random access conflict on the CC4 is resolved and the random access process with conflicts at the cell 2 is ended; the UE obtains the downlink synchronization with the cell 2 and TA, considers that the handover process is successful, accomplishes the reset process of the user interface protocol, the reset including MAC layer reset, PDCP layer reconstruction and RLC layer reconstruction, updates the configurations of the carrier-related MAC and PHY layers of the first data communication modules 2 and 3 and updates the configurations of the carrier-unrelated RRC, PDCP, RLC and MAC layer protocols according to the handover command, the configuration including configuring the bottom layer to adopt an integrity protection algorithm and a ciphering algorithm of the cell 2, the UE starts to communicate with the cell 2 normally on the CC4 and sends a Message5 (handover complete) to the cell 2, and the CC5 can be added after the CC4 is communicated normally. If the UE only receives the PDCCH on the CC5, it can be considered that the random access conflict on the CC5 is resolved and the random access process with conflicts at the cell 2 is ended; the UE obtains the downlink synchronization with the cell 2 and TA, considers that the handover process is successful, accomplishes the reset process of the user interface protocol, the reset including MAC layer reset, PDCP layer reconstruction and RLC layer reconstruction, updates the configurations of the carrier-related MAC and PHY layers of the first data communication modules 1 and 3 and updates the configurations of the carrier-unrelated RRC, PDCP, RLC and MAC layer protocols according to the handover command, the configuration including configuring the bottom layer to adopt an integrity protection algorithm and a ciphering algorithm of the cell 2, the UE starts to communicate with the cell 2 normally on the CC5 and sends a Message5 (handover complete) to the cell 2, and the CC4 can be added after the CC5 is communicated normally. At this moment, the communication with the cell 1 on the first data communication module 3 can be interrupted.

### Preferred Embodiment 5

FIG. 15 shows a diagram of a fifth preferred example according to the embodiment of the present invention; as shown in FIG. 15, cell 1 is the cell of LTE-A and supports the aggregation of two CCs, that is, CC1 and CC2, both of which are located in the frequency band 1 and are continuous; cell 2 is the cell of LTE, wherein the cell 2 is an adjacent cell of the cell 1 and supports only one CC, that is, CC5, which is located in the frequency band 1. The transmitting equipment and receiving equipment of the UE is a set of base band equipment, which has a single frequency band with band width of 40 MHz, a first data communication module and an RACH module; the cell 1 belongs to eNB 1 and the cell 2 belongs to eNB 2.

The current UE is in a connection state in the cell 1 and uses the CC1 and the CC2 at the same time; DC takes charges of the data communication on the CC1 and the CC2. The network side transmits to the UE a measurement task of a trigger event (A3) that the adjacent cell has better quality of service than the serving cell, wherein the carrier frequency of the measured object is CC5. For the flow, refer to the flow shown in FIG. 10 in Embodiment one, no further description is needed here.

The UE performs the measurement, finds that the cell 2 meets the trigger condition of the event A3 and sends the measurement report to the network side.

The network side decides to enable the UE to hand over to the cell 2, and sends a handover preparation command to the cell 2.

After receiving the handover preparation command, the cell 2 allocates a preamble and includes the information in the handover command to send to the cell 1, wherein the handover command further includes the C-RNTI allocated by the cell 2 and other configuration information of the cell 2, then the cell 1 forwards the handover command to the UE.

After the UE receives the handover command, the RACH module and the corresponding physical layer update the configuration of underlying protocol according to the requirement of handover command, and perform the random access process with the cell 2; that is, the RACH module initiates a random access process at the cell 2 and sends a Message1 on the CC5, wherein the Message1 contains the dedicated preamble provided by the cell 2.

After receiving the Message1, the cell 2 reserves resource for the UE and returns a Message2 to the UE, wherein the Message2 includes TA and/or UL grant; here, for simplifying the implementation of UE, the Message2 might not be sent to the UE directly but is sent to the cell 1 through X2 or S1, and then is forwarded to the UE by the cell 1. In this condition, the terminal RACH module only needs to use the uplink carrier resource of the corresponding physical layer.

After receiving the Message2 on the CC5, the UE performs the related processing, the function execution of the RACH module is finished, the random access process without conflict of the UE at the cell 2 is ended, the UE obtains the downlink synchronization with the cell 2 and TA, considers that the handover process is successful, accomplishes the reset process of the user interface protocol, the reset including MAC layer reset, PDCP layer reconstruction and RLC layer reconstruction, updates the configurations of the carrier-related MAC and PHY layers of the first data communication module and updates the configurations of the carrier-unrelated RRC, PDCP, RLC and MAC layer protocols according to the handover command, the configuration including configuring the bottom layer to adopt an integrity protection algorithm and a ciphering algorithm of the cell 2, starts to communicate with the cell 2 normally, sends to the cell 2 a handover complete message, then the cell 2 notifies the core network to perform path switch and interrupt the communication with the cell 1.

To sum up, with the above embodiment of the present invention, the interruption time of the handover in the mobility management can be reduced and even eliminated, thus a seamless handover is achieved and the service experience for the users is improved.

Obviously, those skilled in the art should understand that the modules and steps described above can be implemented by a common computer device; the modules or steps can be integrated on a single computing device or distributed on a network composed of a plurality of computing devices; optionally, the modules or steps can be implemented by a programming code executable by a computing device, thus they can be stored in a storage device to execute by a computing device, and in some conditions the steps described above can be executed in a different order, or they are manufactured into individual integrated circuit module respectively, or several of them can be manufactured into a single integrated circuit module to realize; in this way, the present invention is not limited to any combination of specific hardware and software.

The above is only the preferred embodiment of the present invention and not intended to limit the present invention. For those skilled in the art, various modifications and changes can be made to the present invention. Any modification, equivalent substitute and improvement within the spirit and principle of the present invention are deemed to be included within the protection scope of the present invention.

What is claimed is:

1. A handover method, comprising the steps of:
a terminal receiving a handover command, wherein the handover command is used to indicate that the terminal should be handed over to a target cell; and
the terminal performing a handover process so that it is handed over to the target cell and keeping a data communication with a source cell until a success of the handover process is determined.

2. The method according to claim 1, wherein the handover process comprises: a random access process.

3. The method according to claim 2, wherein after the terminal completes the random access process of handing itself over to the target cell, the method further comprises:
the terminal terminating the data communication with the source cell.

4. The method according to claim 3, wherein after the terminal completes the random access process of handing itself over to the target cell, the method further comprises:
the terminal starting a data communication with the target cell.

5. The method according to claim 2, wherein the random access process comprises one of the following: random access process with conflicts and random access process without conflict.

6. The method according to claim 5, wherein the random access process with conflicts performed by the terminal in order to be handed over to the target cell comprises the following steps:
the terminal sending a random access preamble to the target cell;
the terminal receiving a random access response message from the target cell;
the terminal sending a Message3 to the target cell, wherein the Message3 carries a cell-radio network temporary identity (C-RNTI) of the terminal at the target cell; and
the terminal receiving a Message4 from the target cell, confirming that a random access conflict is resolved.

7-9. (canceled)

10. The method according to claim 6, wherein
the Message4 contains a physical layer physical downlink control channel (PDCCH) signaling, wherein the PDCCH signaling contains content of the C-RNTI of the terminal at the target cell.

11. The method according to claim 6, wherein
when the terminal receives the Message4 and confirms that the random access conflict is resolved, the terminal determines that the handover process is successful.

12. The method according to claim 6, wherein
the target cell is configured to send the random access response message and/or the Message4 to the terminal directly or via the source cell; and
the terminal is configured to send the Message3 to the target cell directly or via the source cell.

13. The method according to claim 5, wherein the random access process without conflict performed by the terminal in order to be handed over to the target cell comprises the following steps:
the terminal sending a random access preamble to the target cell, wherein the random access preamble is a dedicated resource configured for the terminal by the target cell; and
the terminal receiving a random access response message from the target cell.

14. The method according to claim 13, wherein
the target cell is configured to send the random access response message to the terminal directly or via the source cell.

15. The method according to claim 13, wherein
after the terminal receives the random access response message, the terminal determines that the handover process is successful.

16. The method according to claim 11, wherein
after the terminal determines that the handover process is successful, the terminal sends a handover complete message to the target cell.

17. The method according to claim 2, wherein after the terminal receives the handover command and before the success of the handover process, one or more uplink carriers and/or one or more downlink carriers update respective configuration of an underlying protocol according to the handover command and perform respective random access processes with the target cell.

18. The method according to claim 17, wherein the underlying protocol is a carrier-related MAC layer protocol and a physical layer protocol.

19. The method according to claim 2, wherein after the success of the handover process, the terminal updates configuration of an underlying protocol of other carriers according to the handover command, wherein the other carriers refer to carriers configured in the handover command excluding those carriers performing the random access process.

20. The method according to claim 19, wherein the underlying protocol is a carrier-related MAC layer protocol and a physical layer protocol.

21. The method according to claim 2, wherein after the success of the handover process, the terminal updates configuration of a high-layer protocol according to the handover command.

22. The method according to claim 21, wherein the high-layer protocol comprises carrier-unrelated packet data convergence protocol (PDCP), radio link control (RLC) and MAC layer protocols.

23. The method according to claim 21, wherein the high-layer protocol comprises carrier-unrelated radio resource control (RRC) layer protocol.

24. The method according to claim 2, wherein after the success of the handover process, the terminal accomplishes a reset process of a user interface protocol, wherein the reset process comprises MAC layer reset, PDCP layer reconstruction and RLC layer reconstruction.

25. The method according to claim 24, wherein the user interface protocol comprises PDCP, RLC and MAC layer protocols.

26. A terminal, comprising:
a handover module used for receiving a handover command, wherein the handover command is used to indicate that the terminal should be handed over to a target cell;
a communication module used for performing a handover process so that it is handed over to the target cell; and
a first data communication module used for keeping a data communication with a source cell until a success of the handover process is determined.

27. The terminal according to claim 26, wherein, if the handover process is a random access process, the first data communication module is further used for terminating the data communication with the source cell after completing the random access process of handing itself over to the target cell.

28. The terminal according to claim 27, wherein while performing the random access process with conflicts of handing itself over to the target cell, the communication module is further used for sending a random access preamble that carries a common preamble code to the target cell, receiving a random access response message sent by the target cell directly or via the source cell, the message carrying time advance (TA) and/or uplink grant information, sending a Message3 to the target cell, the Message3 carrying an C-RNTI of the terminal at the target cell, receiving from the target cell a Message4 that contains a physical layer PDCCH signaling and confirming that the random access conflict is resolved, and sending a Message5 to the target cell, the Message5 used to indicate a completion of the handover process.

29. The terminal according to claim 27, wherein while performing the random access process without conflict of handing itself over to the target cell, the communication module is further used for sending a random access preamble to the target cell, wherein the random access preamble is a dedicated resource configured for the terminal by the target cell, receiving a random access response message sent by the target cell directly or via the source cell, and directly sending a Message3 to the target cell, wherein the Message3 is used to indicate a completion of the handover process.

30. The terminal according to claim 27, wherein after the handover module receives the handover command and before the success of the handover process, the communication module has one or more uplink carriers and/or one or more downlink carriers updating respective configuration of an underlying protocol according to the handover command and performing respective random access processes with the target cell, wherein the underlying protocol is a carrier-related MAC layer protocol and a physical layer protocol.

31. The terminal according to claim 27, wherein after the success of the handover process, the communication module is further used for updating configuration of an underlying protocol of other carriers according to the handover command, wherein the other carriers refer to carriers configured in the handover command excluding those carriers performing the random access process; the underlying protocol is a carrier-related MAC layer protocol and a physical layer protocol.

32. The terminal according to claim 27, wherein after the success of the handover process, the communication module is further used for updating configuration of a high-layer protocol according to the handover command, wherein the high-layer protocol comprises carrier-unrelated PDCP, RLC and MAC layer protocols.

33. The terminal according to claim 26, wherein the communication module comprises one of the following: a random access RACH module and a second data communication module.

34. The terminal according to claim 33, wherein the second data communication module is further used for, after or before the first data communication module terminates the data communication with the source cell, starting a data communication with the target cell and sending a handover complete message to the target cell after determining a success of the handover process.

35. The method according to claim 15, wherein after the terminal determines that the handover process is successful, the terminal sends a handover complete message to the target cell.
